(19) United States
(12) Patent Application Publication
(10) Pub. No.: US 2003/0223619 A1
(43) Pub. Date: Dec. 4, 2003

(54) Method and apparatus for visual motion recognition

(76) Inventors: Alan Stocker, Zurich (CH); Rodney Douglas, Ruschlikon (CH)

Correspondence Address: Donald S. Dowden, Cooper & Dunham LLP, 1185 Avenue of the Americas, New York, NY, 10036, US

(21) Appl. No.: 10/386,769

(22) Filed: Mar. 12, 2003

(30) Foreign Application Priority Data
Mar. 12, 2002 (EP) EP-02 005 282.5

(51) Int. Cl. G06K 9/00; G06K 9/62

(52) U.S. Cl. 382/107; 382/155

(57) ABSTRACT

Disclosed is a moving object recognition system. The system generates an optical flow vector field based on a two-dimensional brightness signal. The system employs a bi-directional optical flow neural network extended with a motion selective neural network. The motion selective neural network interacts with the optical flow neural network by providing an attentional bias for each of the optical flow neurons. The motion selective neural network is adjustable by input to focus on a certain expected motion. The motion selective neural network can be influenced by additional neural networks which receive a bottom-up input from the motion selective neural network.

### CROSS REFERENCE TO RELATED APPLICATIONS

This application claims the priority of the European application 02 005 282.5, filed Mar. 12, 2002, the disclosure of which is incorporated herein by reference in its entirety.

### BACKGROUND OF THE INVENTION

The invention relates to a method and apparatus for visual motion recognition.

Systems for visual motion recognition are described in U.S. Pat. No. 5,511,133 and in Stocker, A. and R. J. Douglas (1999), computation of smooth optical flow in a feedback connected analog network, in M. S. Kearns, S. A. Solla, and D. A. Cohn (Eds.), Advances in Neural Information Processing Systems 11, Cambridge, Mass., pp. 706-712, MIT Press.

Systems for visual motion recognition are used for obtaining information about moving patterns, such as velocity, position and configuration. The use of neural networks in such systems allows fast and in particular parallel processing of image data. Usually each neuron or unit of a neural network is assigned to a particular sampling position or pixel of the image. For motion detection generally two neural networks are employed, one network for x-directional motion and one network for y-directional motion. Both networks interact. The networks are designed such that the state of the neurons converge to an optical flow (u,v), which is indicative of the velocity vector at a respective point of a moving pattern. The term ‘indicative’ means that the state of a particular neuron is an estimate of the actual velocity component.

The optical flow \vec{v}=(u,v) can e.g. be obtained by minimizing the cost function

H(\vec{v}(x,y,t);ρ,σ)=∫∫(F²+ρS+σB)dxdy (1)

where F, S and B are functions which are defined below. The weight of F, S and B is defined by the parameters ρ and σ. The boundary condition of such networks is usually defined by

\vec{v}′(x,y,t)=0 (along the boundary) (2)

The function F is defined by:

F(\vec{v}(x,y,t))²=(Eₓ·u+E_{y}·v+Eₜ)² (3)

where Eₓ, E_{y}, Eₜ are the partial derivatives of the brightness E at the respective points of the input image data with respect to the x- and y-components and the time, and u,v are the x- and y-components of the optical flow (u,v). The function S is defined by:

S(\vec{v}′(x,y,t))=(uₓ²+u_{y}²+vₓ²+v_{y}²) (4)

where uₓ,u_{y},vₓ,v_{y} are the spatial gradients of the optical flow vector field. The function B is defined by:

B(\vec{v}(x,y,t))=(u−u₀)²+(v−v₀)² (5)

where (u₀,v₀) is a bias potential or reference motion.

The use of the term “input image data” in this document does not imply that the image information is supplied digitally. The information is preferably provided as an analog signal, for example as a voltage signal.

Existing systems are responsive to noise. Noise is erroneously interpreted as small moving objects. Existing systems often don't work reliably if there is more than one moving object. The velocity vector estimations are poor, particularly at the edges of moving patterns.

### BRIEF SUMMARY OF THE INVENTION

Hence, it is a general object of the invention to provide a system of the kind described above which avoids the disadvantages described above at least partially.

Now, in order to implement these and still further objects of the invention, which will become more readily apparent as the description proceeds, the apparatus for visual motion recognition according to the invention is manifested by the features that it comprises an optical flow network to which input image data is applied and which generates an optical flow vector field, wherein said optical flow network comprises optical flow neurons which are connected to a reference motion potential over local bias conductances, and further comprises a motion selective network, which generates an attentional bias, wherein said attentional bias controls said local bias conductances of said optical flow network.

In yet another aspect, the invention relates to a method for determining an optical flow vector field based on input image data, characterized by the steps of:

Applying the input image data to an optical flow network, particularly a bi-directional neural network comprising pairs of optical flow neurons, where each of said optical flow neurons is connected to a reference motion potential over a local bias conductance, generating said optical flow vector field,

Applying said optical flow vector field to a motion selective network, which generates an attentional bias,

Using said attentional bias to control said local bias conductances of said optical flow network.

By employing said motion selective network which controls the local bias conductances of said optical flow network the system can be set up to put its attention on a certain expected motion. For example noise, which is usually not within the range of the expectation, is thereby eliminated.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a schematic view of the networks and their interaction, input and output,

FIG. 2 shows a single unit of the bi-directional optical flow network,

FIG. 3 shows the interaction between the motion selective network and the x-directional optical flow network,

FIG. 4 shows an idealized optical flow field as generated by conventional optical flow networks,

FIG. 5 shows the idealized output of a motion selective network for an expected motion to the left,

FIG. 6 shows the idealized output of the system according to the invention for an expected motion to the left,

FIG. 7 shows the idealized output of a motion selective network for an expected motion to the right,

FIG. 8 shows the idealized output of the system according to the invention for an expected motion to the right, and

FIG. 9 shows a schematic view of the preferred embodiment of the invention, including a camera pointed towards moving sample objects.

### DETAILED DESCRIPTION OF THE INVENTION

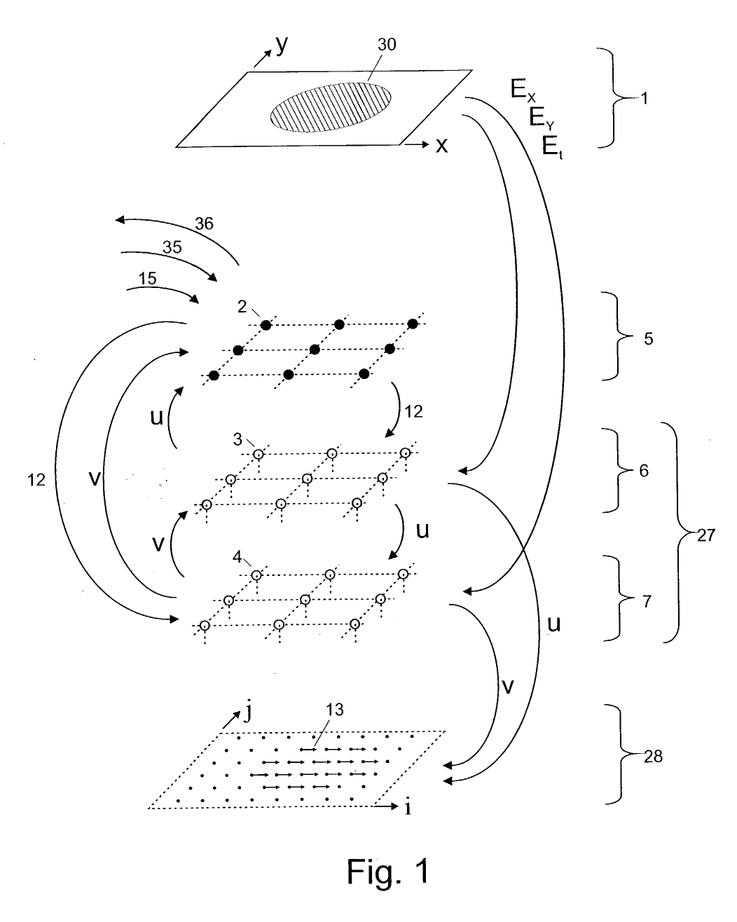

FIG. 1 is a schematic view of an embodiment of the invention. Continuous input image data 1 are sampled at discrete positions (i,j) to generate brightness or intensity values Eᵢⱼ(t). The spatial and temporal derivatives Eₓ, E_{y}, Eₜ of the brightness E are fed into an optical flow network 27. Generally optical flow networks are networks that have image information as an input and optical flow or velocity information as an output. In the preferred embodiment of the invention the optical flow network 27 is bi-directional and consists of two neural networks: An x-directional optical flow network 6 and a y-directional optical flow network 7. The neural networks are designed such that the states of the optical flow neurons 3, 4 converge to a value indicative of the components of a velocity vector of a moving pattern 30. There is a pair of optical flow neurons 3, 4 for each image pixel or discrete sampling position. The arrangement of the neurons is retinotopical. The output of the optical flow network 27 is an optical flow vector field 28 with one optical flow vector 13 for each pair of optical flow neurons 3, 4.

The bi-directional optical flow network 27 interacts with a motion selective network 5.

Generally motion selective networks have an optical flow vector field or velocity vector field as an input and a field of values indicating to which extent a selection criterion was fulfilled as an output. In the preferred embodiment of the invention the selection criterion is the similarity of the optical flow input with an expected motion 19, 20. The selection criterion can be changed dynamically if the motion selective network has an additional input 15 for parameters characterizing the selection criterion. For example if the selection criterion is the similarity with an expected motion 19, 20, these parameters comprise the components of the velocity vector \vec{v}_{Model} of that expected motion 19, 20. The expected motion can also be characterized by a field of velocity vectors. An other example for such a parameter is the expected size Nₘₐₓ of moving patterns as described below.

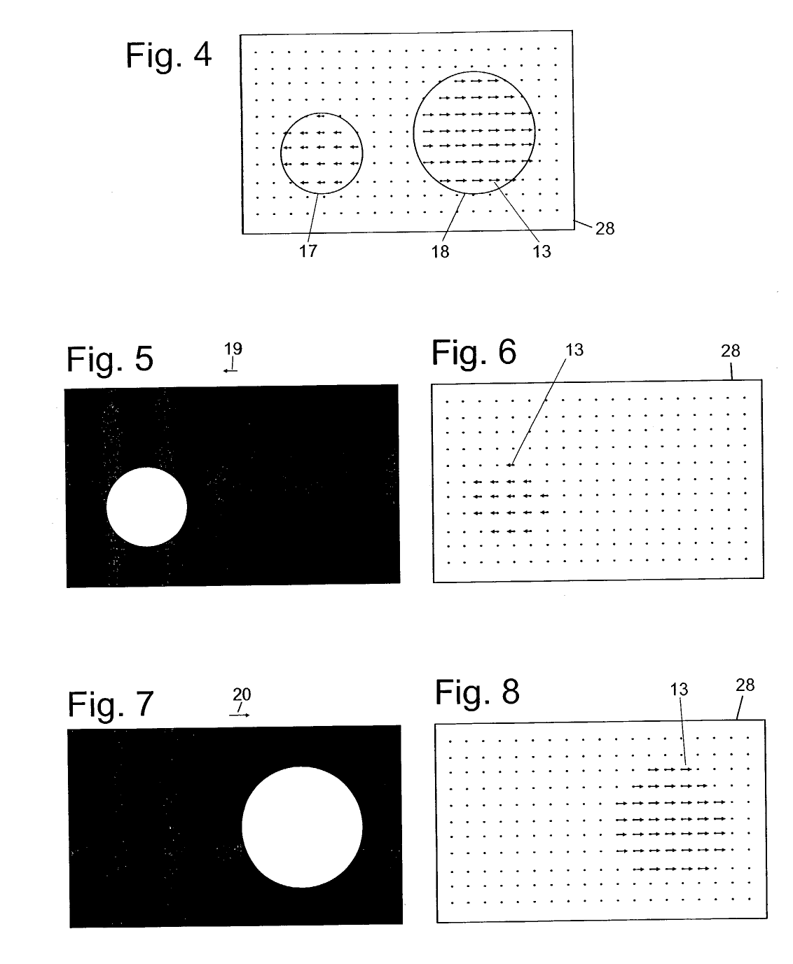

The motion selective network 5 is used to determine whether a certain moving pattern is of interest. The output of the motion selective network 5 provides a measure of the attention to be put on discrete positions of the image. In this manner the output provides an attentional bias 12, which is used to control the optical flow network 27, particularly to inhibit optical flow neurons 3, 4 at positions which are not of interest. Extending the conventional optical flow network 27 with a motion selective network 5 has the advantage that noise is not as easily misinterpreted as a moving object. Objects which are not of interest and are e.g. moving in a different direction than the objects of interest can be ignored by choosing the expected motion 19, 20 accordingly as described in the following on the basis of FIGS. 4 to 8. The motion selective network 5 has the optical flow u, v generated by the optical flow network 27 as an input. The attentional bias 12 is therefor with respect to the optical flow network 27 a feedback signal.

On top of the motion selective network 5, there can be one or more additional networks 37, which are not shown in FIG. 1. These additional networks 37 influence the motion selective network 5 by the top-down input 35. The additional networks 37 receive a bottom-up input 36, for example the attentional bias Aᵢⱼ, from the motion selective network 5. These additional networks 37 are higher level networks performing recognition and/or control tasks at a higher level of abstraction.

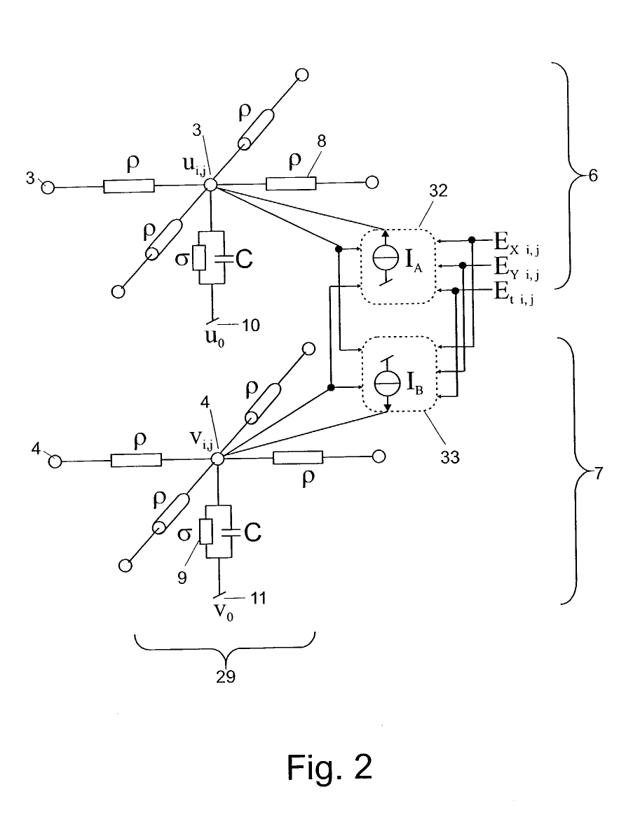

FIG. 2 shows one unit 29 of a bi-directional optical flow network 27. There is a total of m×n such units 29 in the network 27. A unit can be identified by its position (i,j). Each unit corresponds to a particular pixel of the input image data 1. There are m different values for i and n different values for j. Each unit 29 comprises an x-directional optical flow neuron 3 and an y-directional optical flow neuron 4. Each optical flow neuron 3, 4 is connected to four neighboring optical flow neurons 3, 4 with horizontal conductances 8. Each optical flow neuron 3, 4 is connected to a reference motion potential 10, 11 with a local bias conductance 9. The state uᵢⱼ or vᵢⱼ of each optical flow neuron 3, 4 converges to the reference motion potential 10, 11 with a rate depending among other factors on the local bias conductance 9. Each optical flow neuron 3, 4 receives an input current from a controllable current source 32, 33. The current of current sources 32, 33 depends on the spatial and temporal derivatives Eₓ,E_{y},Eₜ of the brightness E of the image. It also depends on the state of both optical flow neurons 3, 4 of the unit 29. Depending on the sign of the current the controllable current source 32, 33 can also act as a current sink.

In the preferred embodiment of the invention the current sources are controlled according to the following formulas:

l_{Aij}∝−Eₓ_{ᵢⱼ}(Eₓ_{ᵢⱼ}uᵢⱼ+E_{y}_{ᵢⱼ}vᵢⱼ+Eₜ_{ᵢⱼ}) (6)

l_{Bij}∝−E_{y}_{ᵢⱼ}(Eₓ_{ᵢⱼ}uᵢⱼ+E_{y}_{ᵢⱼ}vᵢⱼ+Eₜ_{ᵢⱼ}) (7)

The dynamics of an optical flow network 27 consisting of such units 29 can be described by the following equations:

$$\begin{matrix}\begin{matrix}{\dot{u}}_{i j} = - \frac{1}{C} [ {E}_{{x}_{i j}} ( {E}_{{x}_{i j}} {u}_{i j} + {E}_{{y}_{i j}} {v}_{i j} + {E}_{{t}_{ij}} ) - \\ ρ ( {u}_{i + 1 , j} + {u}_{i - 1 , j} + {u}_{i , j + 1} + {u}_{i , j - 1} - 4 {u}_{ij} ) + σ ( {u}_{i j} - {u}_{0} ) ] \end{matrix} & ( 8 ) \\ \begin{matrix}{\dot{v}}_{i j} = - \frac{1}{C} [ {E}_{{y}_{i j}} ( {E}_{{x}_{i j}} {u}_{i j} + {E}_{{y}_{i j}} {v}_{i j} + {E}_{{t}_{ij}} ) - \\ ρ ( {v}_{i + 1 , j} + {v}_{i - 1 , j} + {v}_{i , j + 1} + {v}_{i , j - 1} - 4 {v}_{ij} ) + σ ( {v}_{i j} - {v}_{0} ) ] \end{matrix} & ( 9 )\end{matrix}$$

More general the equations can be written as

\dot{u}ᵢⱼ=F_{U}(uᵢⱼ,vᵢⱼ,u_{neighbors},Eₓ_{ᵢⱼ},E_{y}_{ᵢⱼ},Eₜ_{ᵢⱼ}) (10)

\dot{v}ᵢⱼ=F_{V}(uᵢⱼ,vᵢⱼ,v_{neighbors},Eₓ_{ᵢⱼ},E_{y}_{ᵢⱼ},Eₜ_{ᵢⱼ}) (11)

wherein i is the state of the x-directional optical flow neuron 3 at position (i,j). vᵢⱼ is the state of the y-directional optical flow neuron 3 at position (i,j). \dot{u}ᵢⱼ is the temporal derivative of the state uᵢⱼ. \dot{v}ᵢⱼ is the temporal derivative of the state vᵢⱼ. Eₓ_{ᵢⱼ},E_{y}_{ᵢⱼ},Eₜ_{ᵢⱼ} are the spatial and temporal derivatives of the brightness E at position (i,j). σ is the bias conductance 9 which connects the x-directional optical flow neuron 3 with a bias voltage u₀ and which connects the y-directional optical flow neuron 4 with a bias voltage v₀. u₀ and v₀ are reference motion potentials. The reference motion is represented by a reference motion potential vector (u₀,v₀) and can be changed to adapt the system to a certain constant shift of the total image, for example if the camera recording Eᵢⱼ is moved. Since u₀ and v₀ do not depend on the position (i,j) the reference motion potential vector (u₀,v₀) is a common reference motion potential vector, in particular common for all units of the optical flow network 27. ρ is the horizontal conductance which connects the optical flow neuron 4 at position (i,j) with its four nearest neighbors at positions (i+1,j), (i−1,j), (i,j+1) and (i,j−1). C is the capacity by which each neuron is connected to a constant potential, for example u₀ or v₀. Neurons at the boundaries of the m×n network have only three or two such nearest neighbors. F_{U} and F_{V} are functions. The conductances ρ and σ can be implemented using active or passive circuitry.

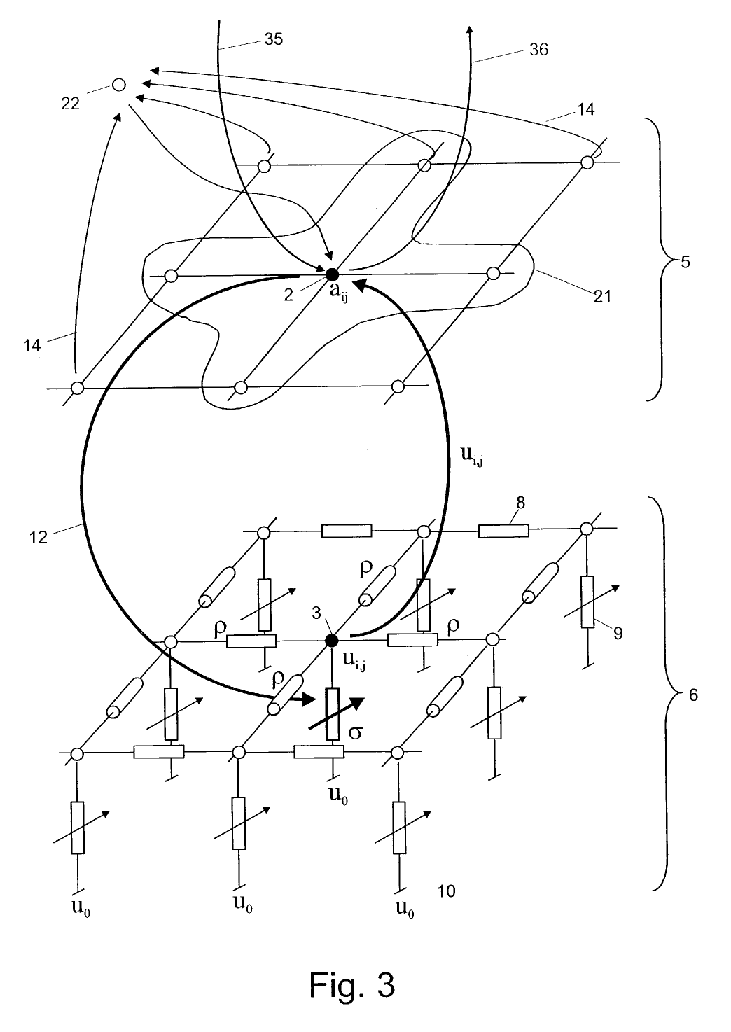

FIG. 3 shows the motion selective network and its interaction with the x-directional optical flow network 6. The interaction with the v-directional optical flow network 7 is of the same nature and is not shown. The motion selective network 5 comprises a motion selective neuron 2 with state aᵢⱼ at each discrete position (i,j). From each motion selective neuron 2 there originates an activation 14. The activation is directed to other motion selective neurons 2, to a global inhibitory unit 22, to control the bias conductance 9 of the corresponding optical flow neurons 3, 4, or to influence one or more additional neural networks 37 by their bottom-up input 36.

The activation 14 is generated as defined by a nonlinear activation function g:

Aᵢⱼ=g(aᵢⱼ) (12)

Wherein Aᵢⱼ is the activation originating from the neuron at position (i,j) with state aᵢⱼ.

In the preferred embodiment of the invention the nonlinear activation function is sigmoid, particularly as follows:

$${A}_{i j} = g ( {a}_{i j} ) = \frac{1}{2} ( tanh ( \frac{{a}_{i j}}{{a}_{0}} ) + 1 ) \qquad ( 13 )$$

In the preferred embodiment of the invention all motion selective neurons 2 take the same effect on the global inhibitory unit 22. In the preferred embodiment of the invention the dynamics of the motion selective network 5 are defined as follows:

$${\dot{a}}_{i j} = - \frac{1}{C} [ \frac{{a}_{i j}}{R} + ( α + β ) {\sum }_{kl} {A}_{k l} - α {A}_{i j} - β {N}_{max} - γ \\ {\sum }_{neighbors} {A}_{neighbors} - δ ( {\overline{v}}_{i j} \cdot {\overline{v}}_{Model} ) ] \qquad ( 14 )$$

wherein

$${\overline{v}}_{i j} = ( \begin{matrix}{u}_{i j} \\ {v}_{i j}\end{matrix} ) \qquad ( 15 )$$

and C is a constant, R is the input resistance and α, β, γ and δ are constants (α+β) is a measure of the weight of the global inhibitory unit 22. α is a measure of the self-excitation of the motion selective neuron 2. \vec{v}_{Model} is the expected motion 15, 20.

The scalar product −δ(\vec{v}ᵢⱼ·\vec{v}_{Model}) in formula (14) causes the motion selective network 5 to select optical flow which is similar to the expected motion \vec{v}_{Model}. The scalar product can be replaced by other terms, in particular a norm −δ∥\vec{v}ᵢⱼ∥. In this case the motion selective network 5 selects fast patterns, independent of their direction.

The motion selective network 5 is a multiple-winner-take-all network (mWTA-network). Such networks are similar to conventional winner-take-all networks (WTA-networks), with the exception that the total activity is forced to Nₘₐₓ, the number of winners. In this application the total activity Nₘₐₓ corresponds to the expected size of the moving pattern or to the size of attention. While \vec{v}_{Model} allows to direct the attention of the system to a certain direction and velocity of motion, Nₘₐₓ allows to adjust the system to focus on moving objects 31 of a certain size.

More generally the dynamics of the motion selective network 5 can be described by the formula:

aᵢⱼ=Z(g₁(aᵢⱼ)+g₂(a_{neighbors1})+g₃(a_{neighbors2}),uᵢⱼ,vᵢⱼ,lᵢⱼ) (16)

Wherein g₁,g₂,g₃ and Z are different, non-constant functions. Z is such that the state of network converges for constant u and v. a_{neighbors1} is a set of the states aₖₗ of motion selective neurons 2 in a first defined neighborhood 21 around position (i,j). In a preferred embodiment of the invention the set comprises only the four nearest neighbors at positions (i+1,j), (i−1,j) (i,j+1) and (i,j−1). a_{neighbors2} is a set of the states aₖₗ of motion selective neurons 2 in a second defined neighborhood. The second defined neighborhood usually comprises all neurons of the first defined neighborhood and is therefore bigger. In a preferred embodiment of the invention the second neighborhood comprises all motion selective neurons 2 in the network 5. uᵢⱼ,vᵢⱼ is with respect to the motion selective network a bottom-up input 34, while lᵢⱼ is a top-down input 35. In the preferred embodiment of the invention lᵢⱼ is dynamic and is a function of values provided by one or more additional networks 37.

The bias conductances 9 at each position (i,j) of the optical flow network 6 and 7 are controlled by the activation 14 of the corresponding motion selective neuron 2 as defined by the formula:

σᵢⱼ=σ₁+(1−Aᵢⱼ)σ₂ (17)

wherein σᵢⱼ is the bias conductance 9 of a optical flow neuron 3, 4 at position (i,j), σ₁ is a minimal bias conductance and σ₁+σ₂ is a maximal bias conductance. The relationship can generally be defined by any formula:

σᵢⱼ=f(Aᵢⱼ) (18)

In an implementation or circuit of the neural network 6, 7 the controllable bias conductance 9 is usually not a resistor. Instead it is an active element, controllable by a voltage and implemented as an arrangement of transistors, for example FETs, as well known to persons skilled in the art.

FIG. 4 shows an idealized optical flow vector field 28 as generated by conventional ideal optical flow networks without a particular focus of attention. A first pattern 17 is moving to the left, a second pattern 18 is moving to the right.

FIG. 5 shows the idealized output or activation of a motion selective network 5 for an expected motion 19 to the left. Black indicates that the optical flow in this region is to be suppressed. White indicates the detection of a moving pattern with the characteristics the system is tuned for. The output shown in the diagram is simplified in that it takes only two discrete values, illustrated in black and white. The output of the actual system takes continues values.

FIG. 6 shows the idealized output of the system according to the invention for an expected motion 19 to the left. The optical flow vector field 28 shows basically only the pattern 17 moving similar to the expected motion 19. The pattern 18 which is moving in the opposite direction is ignored and without effect on the output optical flow vector field 28.

FIG. 7 shows the idealized output of a motion selective network 5 for an expected motion 20 to the right. Black indicates that the optical flow in this region is to be ignored.

FIG. 8 shows the output of the system according to the invention for an expected motion 20 to the right. The optical flow vector field 28 shows only the pattern 18 moving similar to the expected motion 19, while the pattern 17 is ignored.

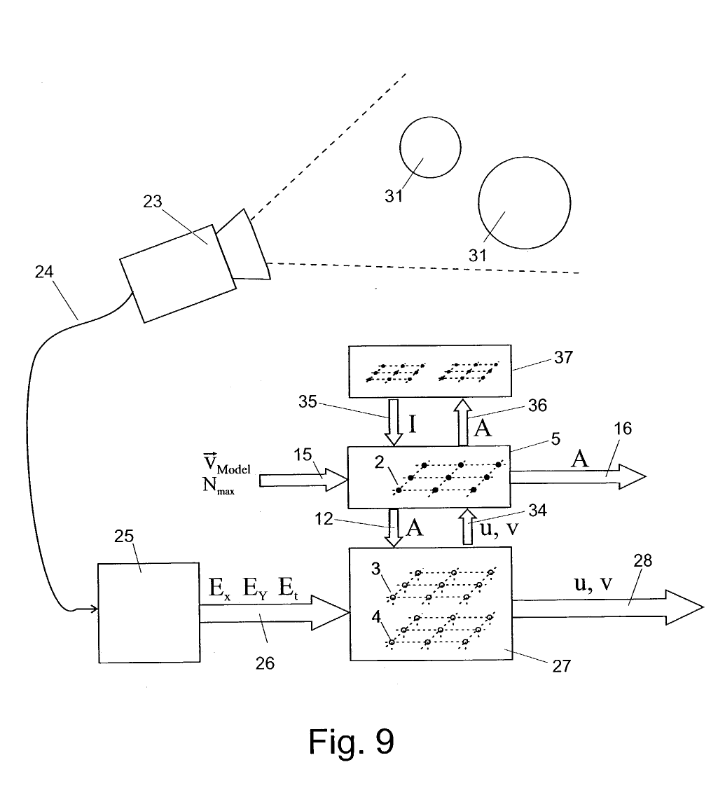

FIG. 9 shows a schematic view of the preferred embodiment of the invention, including a camera 23 pointed towards moving sample objects 31. The camera 23, particularly a CCD-camera, produces a two-dimensional brightness signal 24 input stage 25 calculates spatial and temporal derivatives 26 of the brightness. The two dimensional optical flow network 27 generates an optical flow vector field 28 based on these derivatives 26. The optical flow network 27 is biased by the selective network 5, which generates an attentional bias 12 based on a dynamic bottom up input 34, which is in particular an optical flow vector field, and an input 15, which is a selection criterion. The selection criterion is for example provided by a vector \vec{v}_{Model} which characterizes an expected motion 19, 20 and a number Nₘₐₓ relating to the expected size of moving objects. The motion selective network can be enhanced by one or more additional networks 37 which influence the motion selective network 5 by a top-down input 35, in particular an input lᵢⱼ(t) for each motion selective neuron 2. The additional neural networks 37 may receive a bottom-up input 36 from the motion selective network 5, in particular an attentional bias. The additional neural networks 37 do not necessarily have the same number, density and topography of neurons as the motion selective network 5. The input or activation lᵢⱼ(t) of a motion selective neuron 2 at position (i,j) is in particular a function of values provided by one or more of the additional networks 37.

In systems for visual motion recognition with optical neural networks the term “bottom-up” is generally used for “towards a higher level of abstraction. “top-down” is used for “towards a lower level of abstraction”. The lowest level of abstraction within the system is the input image data provided by the camera.

The neural networks 5, 27, 37 can be implemented as analog circuits. An example of such circuits is described in the publication Stocker, A. and R. J. Douglas (1999), computation of smooth optical flow in a feedback connected analog network, in M. S. Kearns, S. A. Solla, and D. A. Cohn (Eds.), Advances in Neural Information Processing Systems 11, Cambridge, Mass., pp 706-712, MIT Press.

The neural networks 5, 27 can also be implemented using a computer system. The behavior of the neural networks is simulated with a special software. Better performance in the simulation of neural networks can be achieved by using parallel computer systems.

The output of the system is the optical flow vector field 28 and attentional bias matrix 16. This is an advantage over conventional systems which have usually only the optical vector field output. The outputs are used for example for recording, visualization or further processing by other components or systems such as controllers. Depending on the application only one of the two outputs 28, 16 may actually be used.

Even though the system is designed mainly for a certain number of m×n image pixels or units the number of units may be changed at certain stages of the system, in particular by resampling. Especially the input stage 25 will produce better values for the derivatives Eₓ, E_{y} and Eₜ if the input provided by the camera 23 has a higher resolution than the output required for the optical flow network 27.

Even though, in the following, the invention is primarily claimed in terms of an apparatus, it must be noted that the applicant reserves the right to claim the invention with a corresponding set of method claims.

While there are shown and described presently preferred embodiments of the invention, it is to be distinctly understood that the invention is not limited thereto but may be otherwise variously embodied and practised within the scope of the following claims.

1. Apparatus for visual motion recognition based on input image data comprising an optical flow network to which said input image data is applied and which generates an optical flow vector field, wherein said optical flow network comprises optical flow neurons which are connected to a reference motion potential over local bias conductances, and further comprising a motion selective network, which generates an attentional bias, wherein said attentional bias controls said local bias conductances of said optical flow network.

2. Apparatus of claim 1 wherein said optical flow neurons are connected to a common reference motion potential or to components of a common reference motion potential vector.

3. Apparatus of claim 1 wherein said motion selective network comprises an input which is connected to an output of said optical flow network.

4. Apparatus of claim 1 wherein said attentional bias is generated based on said optical flow vector field.

5. Apparatus of claim 1 wherein said motion selective network has a changeable selection criterion.

6. Apparatus of claim 5, wherein said motion selective network comprises an input for said changeable selection criterion.

7. Apparatus of claim 5 wherein said changeable selection criterion comprises the expected size of a moving pattern or the size of attention.

8. Apparatus of claim 5 wherein said changeable selection criterion comprises the similarity of an optical flow with an expected motion.

9. Apparatus of claim 8, wherein said motion selective network comprises an input for said changeable selection criterion which comprises a vector or a vector field indicative of said expected motion.

10. Apparatus of claim 1, wherein said motion selective network comprises motion selective neurons and has the dynamics:
\dot{a}ᵢⱼ=Z(g₁(aᵢⱼ)+g₂(a_{neighbors1})+g₃(a_{neighbors2}),uᵢⱼ,vᵢⱼ)
wherein g₁,g₂,g₃ and Z are different, non constant functions, aᵢⱼ is the state of the motion selective neuron at position (i,j), \dot{a}ᵢⱼ is the temporal derivative of the state of the motion selective neuron at position (i,j), a_{neighbors1} is a set of the states of motion selective neurons in a first defined neighborhood around position (i,j), a_{neighbors2} is the set of the states of motion selective neurons in a second defined neighborhood around position (i, j) and uᵢⱼ,vᵢⱼ are the states of the said optical flow neurons (3, 4) at position (i,j).

11. Apparatus of claim 10 wherein said first defined neighborhood of a motion selective neuron at position (i,j) comprises only the four nearest neighbors at positions (i+1,j), (i−1,j), (i,j+1) and (i,j−1).

12. Apparatus of claim 10 wherein said second defined neighborhood comprises all motion selective neurons of said motion selective network.

13. Apparatus of claim 10 wherein said motion selective network is a multiple-winner-take-all network.

14. Apparatus of claim 13 wherein said multiple-winner-take-all network has a number of winners which is changeable to select a certain size of attention.

15. Apparatus of claim 10 wherein said motion selective neurons of said motion selective network comprise means for generating an activation defined by a nonlinear activation function:
Aᵢⱼ−g(aᵢⱼ)
wherein Aᵢⱼ is the activation originating from the motion selective neuron at position (i,j) and g is the activation function.

16. Apparatus of claim 15 wherein the dynamics of said motion selective network are defined by one of the following formulas:
$$\begin{matrix}{\dot{a}}_{i j} = - \frac{1}{C} [ \frac{{a}_{i j}}{R} + ( α + β ) {\sum }_{ij} {A}_{ij} - α {A}_{i j} - β {N}_{max} - \\ \begin{matrix}\begin{matrix}γ {\sum }_{neighbors} {A}_{neighbors} - δ ( {\overline{v}}_{i j} \cdot {\overline{v}}_{Model} ) ] \\ {\dot{a}}_{i j} = - \frac{1}{C} [ \frac{{a}_{i j}}{R} + ( α + β ) {\sum }_{ij} {A}_{ij} - α {A}_{i j} - β {N}_{max} -\end{matrix} \\ γ {\sum }_{neighbors} {A}_{neighbors} - δ ‖ {\overline{v}}_{i j} ‖ ] \end{matrix}\end{matrix}$$
wherein C is a constant, R is the input resistance and α, β, γ and δ are constants, Nₘₐₓ is the number of winners in a winner-take-all-network, and A_{neighbors} is a set of activations originating from motion selective neurons in said first defined neighborhood of the motion selective neuron at position (i,j), \vec{v}_{Model} is an expected motion and \vec{v}_{i,j} is an optical flow vector defined by the output uᵢⱼ,vᵢⱼ of the optical flow network as follows:
$${\overline{v}}_{i j} = ( \begin{matrix}{u}_{i j} \\ {v}_{i j}\end{matrix} )$$

17. Apparatus of claim 15 wherein the nonlinear activation function g is sigmoid.

18. Apparatus of claim 17 wherein the nonlinear activation function g is defined by:
$${A}_{i j} = g ( {a}_{i j} ) = \frac{1}{2} ( tanh ( \frac{{a}_{i j}}{{a}_{0}} ) + 1 )$$
wherein a₀ is a bias value of the state of the motion selective neurons.

19. Apparatus of claim 15 wherein said local bias conductances of said optical flow network are controllable by said motion selective network as defined by the formula:
σᵢⱼ=f(Aᵢⱼ)
particularly as defined by the formula:
σᵢⱼ=f(Aᵢⱼ)=σ₁+(1−Aᵢⱼ)σ₂
wherein σᵢⱼ is said local bias conductance of the optical flow neuron at position (i,j), σ₁ is a constant minimum bias conductance value and σ₁+σ₂ is a constant maximum bias conductance value.

20. Apparatus of claim 1 wherein said motion selective network comprises a global inhibitory unit which is activatable by all of said motion selective neurons.

21. Apparatus of claim 20 wherein each motion selective neuron is connected for receiving input from said inhibitory unit.

22. Apparatus of claim 1 wherein said input image data is a brightness signal containing a time and position dependent brightness Eᵢⱼ(t).

23. Apparatus of claim 22 comprising means for generating spatial and temporal derivatives Eₓ,E_{y},Eₜ of said brightness Eᵢⱼ(t).

24. Apparatus of claim 23 wherein said means for generating spatial and temporal derivatives Eₓ,E_{y},Eₜ of said brightness Eᵢⱼ(t) provide an input for said optical flow network.

25. Apparatus of claim 1 wherein said optical flow network comprises two neural networks, one for an x-dimension and one for an y-dimension, wherein each x directional optical flow neuron at a position (i,j) has a state uᵢⱼ and each v-directional optical flow neuron at a position (ij) has a state vᵢⱼ, wherein uᵢⱼ and vᵢⱼ are indicative of the velocity of a pattern at position (i,j) moving at a given velocity.

26. Apparatus of claim 25 comprising means for generating spatial and temporal derivatives Eₓ,Eᵥ,Eₜ of said brightness Eᵢⱼ(t) wherein the dynamics of said optical flow network are defined by the formulas:
$$\begin{matrix}\begin{matrix}{\dot{u}}_{i j} = - \frac{1}{C} [ {E}_{{x}_{i j}} ( {E}_{{x}_{i j}} {u}_{i j} + {E}_{{y}_{i j}} {v}_{i j} + {E}_{{t}_{ij}} ) - \\ ρ ( {u}_{i + 1 , j} + {u}_{i - 1 , j} + {u}_{i , j + 1} + {u}_{i , j - 1} - 4 {u}_{ij} ) + σ ( {u}_{i j} - {u}_{0} ) ] \end{matrix} & \\ \begin{matrix}{\dot{v}}_{i j} = - \frac{1}{C} [ {E}_{{y}_{i j}} ( {E}_{{x}_{i j}} {u}_{i j} + {E}_{{y}_{i j}} {v}_{i j} + {E}_{{t}_{ij}} ) - \\ ρ ( {v}_{i + 1 , j} + {v}_{i - 1 , j} + {v}_{i , j + 1} + {v}_{i , j - 1} - 4 {v}_{ij} ) + σ ( {v}_{i j} - {v}_{0} ) ] \end{matrix} & \end{matrix}$$
wherein \dot{u}ᵢⱼ is the temporal derivative of the state uᵢⱼ of the x-directional optical flow neuron at position (i,j) and \dot{v}ᵢⱼ is the temporal derivative of the state vii of the y-directional optical flow neuron at position (i,j) and u₀,v₀ is the reference motion potential.

27. Apparatus of claim 1 comprising one or more additional networks, which receive a bottom-up input from said motion selective network and which provide a top-down input for said motion selective network.

28. Apparatus of claim 27 wherein said top-down input for said motion selective network is provided to control said motion selective network dynamically.

29. Apparatus of claim 10 comprising one or more additional networks, which receive a bottom-up input from said motion selective network and which provide a top-down input for said motion selective network wherein each motion selective neuron at position (i,j) receives an activation wherein said activation lᵢⱼ(t) is a function of values provided by one or more of said additional networks.

30. Apparatus of claim 1 wherein at least one of the neural networks is implemented as an analog circuit.

31. Apparatus of claim 1 wherein at least one of the neural networks is implemented with a computer system, particularly with a parallel computer system, comprising hardware and software, particularly comprising a neural network simulation software.

32. Method for determining an optical flow vector field based on input image data, characterized by the steps of:
Applying the input image data to an optical flow network, particularly a bi-directional neural network comprising pairs of optical flow neurons, where each of said optical flow neurons is connected to a reference motion potential over a local bias conductance, generating said optical flow vector field,
Applying said optical flow vector field to a motion selective network, which generates an attentional bias,
Using said attentional bias to control said local bias conductances of said optical flow network.
